(19) United States
(12) Patent Application Publication
(10) Pub. No.: US 2019/0158014 A1
(43) Pub. Date: May 23, 2019

(54) APPARATUSES, SYSTEMS, AND METHODS FOR A THREE-AXIS SPACE FRAME, PHOTOVOLTAIC, AND INFRASTRUCTURE STRUCTURAL SYSTEM

(71) Applicant: Quest Renewables, LLC, Atlanta, GA (US)

(72) Inventors: Joseph N. Goodman, Snowmass Village, CO (US); Will Arnold, Atlanta, GA (US); Beau Baldock, Atlanta, GA (US)

(21) Appl. No.: 16/191,176

(22) Filed: Nov. 14, 2018

Related U.S. Application Data
(60) Provisional application No. 62/585,860, filed on Nov. 14, 2017.

(51) Int. Cl. H02S 30/10; H02S 20/10; H02S 20/22

(52) U.S. Cl. CPC H02S 30/10; H02S 20/22; H02S 20/10

(57) ABSTRACT

Apparatuses, systems, and methods for a three-axis space frame that supports PV systems or other infrastructure technologies, which maximizes the space and structural capacity for given constraints in foundation count and/or structural cost. The disclosed three-axis space frame generally comprises one or more primary axis space frames, secondary axis space frames, and tertiary axis space frames. In one embodiment, the primary axis space frames run parallel to each other and support one or multiple PV panels or other loads. The secondary axis space frames, in one embodiment, run perpendicular to the primary axis space frames, connecting and supporting the primary axis space frames. Generally, the tertiary axis space frames attach the secondary axis space frames to the ground or alternative boundary condition (e.g., parking garage, underwater foundation, flotation device, etc.), thereby supporting the three-axis space frame.

### CROSS REFERENCE TO RELATED APPLICATIONS

This application claims priority to, the benefit under 35 U.S.C. § 119 of, and incorporates by reference herein in its entirety U.S. Provisional Patent Application No. 62/585,860, filed Nov. 14, 2017, and entitled “Apparatuses, Systems, and Methods for Three-Axis Space Frame, Photovoltaic, and Infrastructure Structural System.”

### TECHNICAL FIELD

The present apparatuses, systems, and methods relate generally to photovoltaic arrays and, more particularly, to deployment and support of photovoltaic systems and other infrastructure projects via a three-axis space frame.

### BACKGROUND

Deployment of photovoltaic (“PV”) systems generally entails support of large module surface areas that are subject to high wind, snow, earthquake, and other environmental loads. Traditionally, accommodation for these loads is structurally intensive with significant material (e.g., steel, etc.) and foundation requirements, which can make the systems both cost and spatially prohibitive. Further, the need for significant numbers of foundations to support these systems is generally not compatible with factory pre-assembly of the systems that could improve labor productivity.

Therefore, there is a long-felt but unresolved need for a system that increases the supported surface area of PV systems or other infrastructure technologies with less structural material and fewer foundation requirements.

### BRIEF SUMMARY OF THE DISCLOSURE

Briefly described, and according to one embodiment, aspects of the present disclosure generally relate to apparatuses, systems, and methods for deployment and support of photovoltaic systems and other infrastructure projects via a three-axis space frame.

In various embodiments, a three-axis space frame supports PV systems or other infrastructure technologies (e.g., light rail, shade systems, etc.), which maximizes the space and structural capacity for given constraints in foundation count and/or structural cost. The disclosed three-axis space frame generally comprises one or more primary axis space frames, secondary axis space frames, and tertiary axis space frames. In one embodiment, the primary axis space frames run parallel to each other and support one or multiple PV panels or other loads. The secondary axis space frames, in one embodiment, run perpendicular to the primary axis space frames, connecting and supporting the primary axis space frames. Generally, the tertiary axis space frames attach the secondary axis space frames to the ground or alternative boundary condition (e.g., parking garage, underwater foundation, flotation device, etc.), thereby supporting the three-axis space frame.

In one embodiment, a three-axis space frame structural system, comprising: at least two primary axis space frames, wherein the at least two primary axis space frames are generally oriented parallel to each other and to a primary axis and wherein each of the at least two primary axis space frames comprises at least two upper chords; at least one secondary axis space frame operatively connected to the at least two primary axis space frames, wherein the at least one secondary axis space frame is generally oriented perpendicular to the primary axis and parallel to a secondary axis; at least one tertiary axis space frame operatively connected to the at least one secondary axis space frame, wherein the at least one tertiary axis space frame is generally oriented perpendicular to the primary and secondary axes and parallel to a tertiary axis; and at least one photovoltaic panel affixed to one or more of the at least two upper chords.

In one embodiment, a three-axis space frame structural system, comprising: at least two primary axis space frames, wherein the at least two primary axis space frames are generally oriented parallel to each other and to a primary axis and wherein each of the at least two primary axis space frames comprises at least two upper chords; at least one secondary axis space frame operatively connected to the at least two primary axis space frames, wherein the at least one secondary axis space frame is generally oriented perpendicular to the primary axis and parallel to a secondary axis; at least one tertiary axis space frame operatively connected to at least one of the at least two primary axis space frames, wherein the at least one tertiary axis space frame is generally oriented perpendicular to the primary and secondary axes and parallel to a tertiary axis; and at least one photovoltaic panel affixed to one or more of the at least two upper chords.

In one embodiment, a method of installing a three-axis space frame structural system, comprising the steps of: assembling at least two primary axis space frames, wherein each of the at least two primary axis space frames comprises at least two upper chords; assembling at least one secondary axis space frame; affixing the at least one secondary axis space frame to the at least two primary axis space frames such that the at least two primary axis space frames are generally oriented parallel to each other and to a primary axis and the at least one secondary axis space frame is generally oriented perpendicular to the primary axis and parallel to a secondary axis; affixing one or more photovoltaic panels to the upper chords; and affixing the at least one secondary axis space frame or at least one of the at least two primary axis space frames to a tertiary axis space frame such that the at least one tertiary axis space frame is generally oriented perpendicular to the primary and secondary axes and parallel to a tertiary axis.

According to one aspect of the present disclosure, the system, wherein each of the at least two primary axis space frames further comprises at least one lower chord, wherein the at least one secondary axis space frame comprises at least one upper chord and at least two lower chords, and wherein the at least one upper chord is affixed to at least one of the at least two upper chords and the at least two lower chords are affixed to the at least one of the at least one lower chord. Furthermore, the system, wherein the at least one tertiary axis space frame comprises a plurality of struts that are affixed to either the at least one upper chord or the at least two lower chords. Moreover, the system, wherein the at least one tertiary axis space frame is further operatively connected to at least one of the at least two primary axis space frames and wherein the plurality of struts are further affixed to either the at least two upper chords or the at least one lower chord. Further, the system, wherein the at least one tertiary axis space frame is further operatively connected to a boundary condition comprising a pedestal, a building, a parking lot, or a parking garage, and wherein the tertiary axis is generally oriented perpendicular to the boundary condition. Additionally, the system, further comprising at least two secondary axis space frames operatively connected to the at least two primary axis space frames and generally oriented perpendicular to the primary axis and parallel to the secondary axis and each other. Also, the system, further comprising at least two tertiary axis space frames, wherein each of the at least two tertiary axis space frames is operatively connected to at least one of the at least two secondary axis space frames and is generally oriented perpendicular to the primary and secondary axes and parallel to the tertiary axis and each other. In addition, the system, further comprising at least four primary axis space frames generally oriented parallel to each other and to the primary axis.

According to one aspect of the present disclosure, the system, wherein each of the at least two primary axis space frames further comprises at least one lower chord, wherein the at least one secondary axis space frame comprises at least one upper chord and at least two lower chords, and wherein the at least one upper chord is affixed to at least one of the at least two upper chords and the at least two lower chords are affixed to the at least one of the at least one lower chord. Furthermore, the system, wherein the at least one tertiary axis space frame comprises a plurality of struts that are affixed to either the at least two upper chords or the at least one lower chord. Moreover, the system, wherein the at least one tertiary axis space frame is further operatively connected to the at least one secondary axis space frame and wherein the plurality of struts are further affixed to either the at least one upper chord or the at least two lower chords. Further, the system, wherein the at least one tertiary axis space frame is further operatively connected to a boundary condition comprising a pedestal, a building, a parking lot, or a parking garage, and wherein the tertiary axis is generally oriented perpendicular to the boundary condition. Additionally, the system, further comprising at least two secondary axis space frames operatively connected to the at least two primary axis space frames and generally oriented perpendicular to the primary axis and parallel to the secondary axis and each other. Also, the system, further comprising at least two tertiary axis space frames, wherein each of the at least two tertiary axis space frames is operatively connected to at least one of the at least two primary axis space frames and is generally oriented perpendicular to the primary and secondary axes and parallel to the tertiary axis and each other. In addition, the system, further comprising at least four primary axis space frames generally oriented parallel to each other and to the primary axis.

According to one aspect of the present disclosure, the method, further comprising the step of affixing the tertiary axis space frame to a boundary condition comprising a pedestal, a building, a parking lot, or a parking garage, wherein the tertiary axis is generally oriented perpendicular to the boundary condition. Furthermore, the method, wherein the step of assembling at least one secondary axis space frame further comprises the step of assembling at least two secondary axis space frames. Moreover, the method, wherein the step of affixing the at least one secondary axis space frame or the at least one of the at least two primary axis space frames to a tertiary axis space frame further comprises the step of affixing both the at least one secondary axis space frame and the at least one of the at least two primary axis space frames to a tertiary axis space frame.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 (comprising FIGS. 1A and 1B) illustrates an exemplary three-axis space frame according to one embodiment of the present disclosure.

FIG. 2 (comprising FIGS. 2A and 2B) illustrates an exemplary alternative three-axis space frame according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to deployment and support of photovoltaic systems and other infrastructure projects via a three-axis space frame

In various embodiments, a three-axis space frame supports PV systems or other infrastructure technologies (e.g., light rail, shade systems, etc.), which maximizes the space and structural capacity for given constraints in foundation count and/or structural cost. The disclosed three-axis space frame generally comprises one or more primary axis space frames, secondary axis space frames, and tertiary axis space frames. In one embodiment, the primary axis space frames run parallel to each other and support one or multiple PV panels or other loads. The secondary axis space frames, in one embodiment, run perpendicular to the primary axis space frames, connecting and supporting the primary axis space frames. Generally, the tertiary axis space frames attach the secondary axis space frames to the ground or alternative boundary condition (e.g., parking garage, underwater foundation, flotation device, etc.), thereby supporting the three-axis space frame.

### Exemplary Embodiments

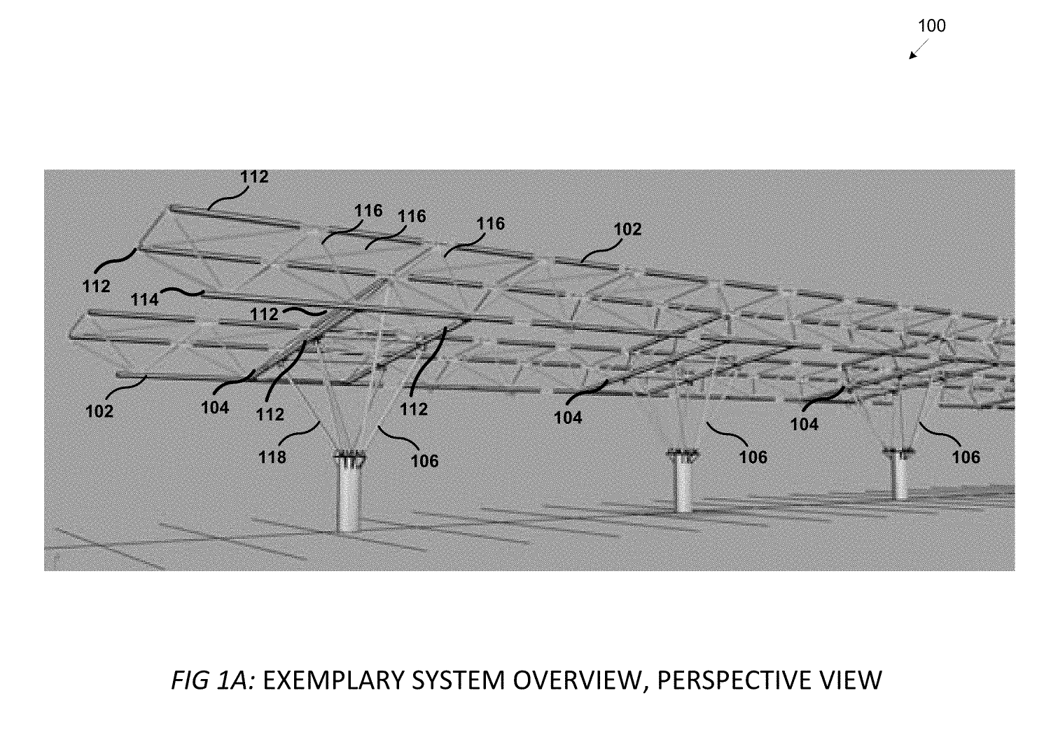

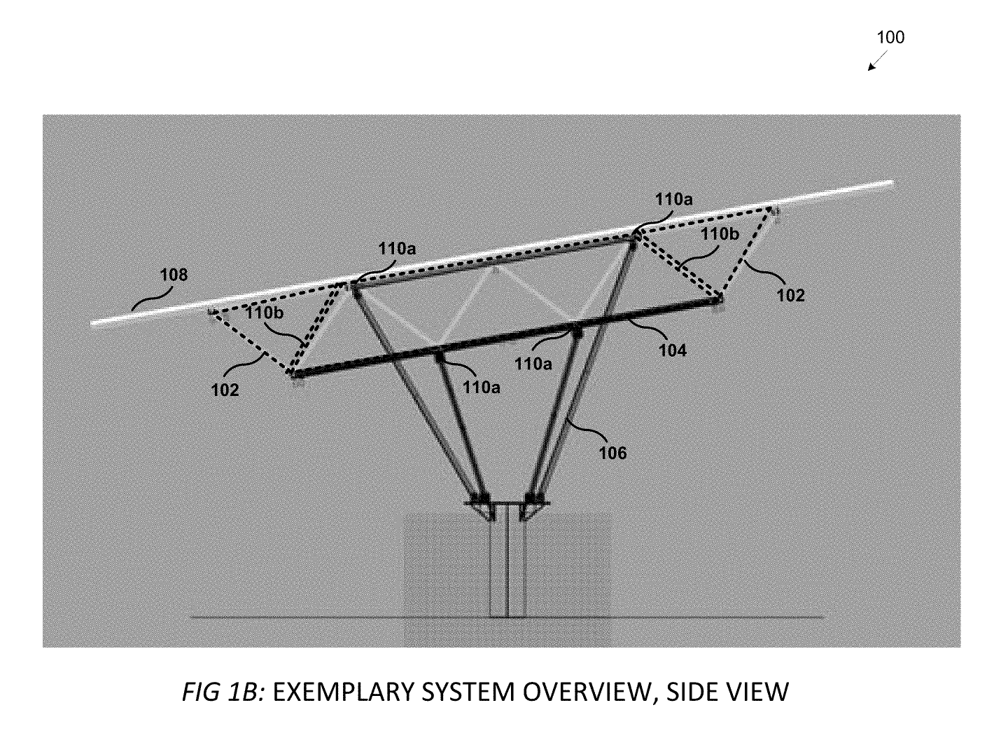

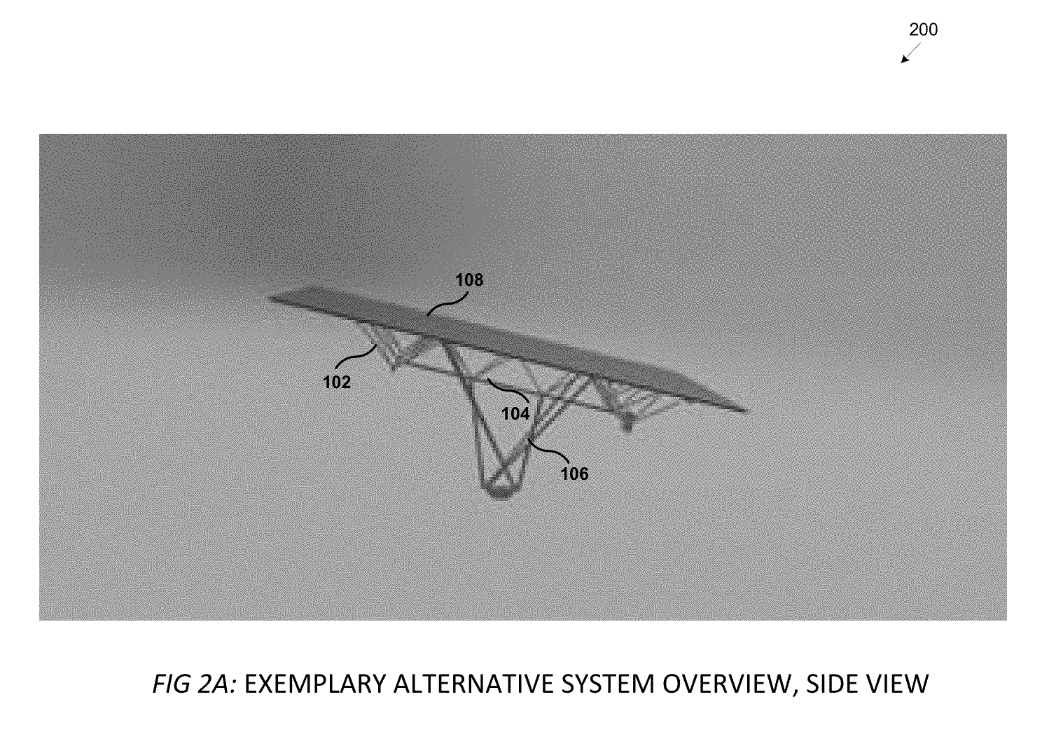

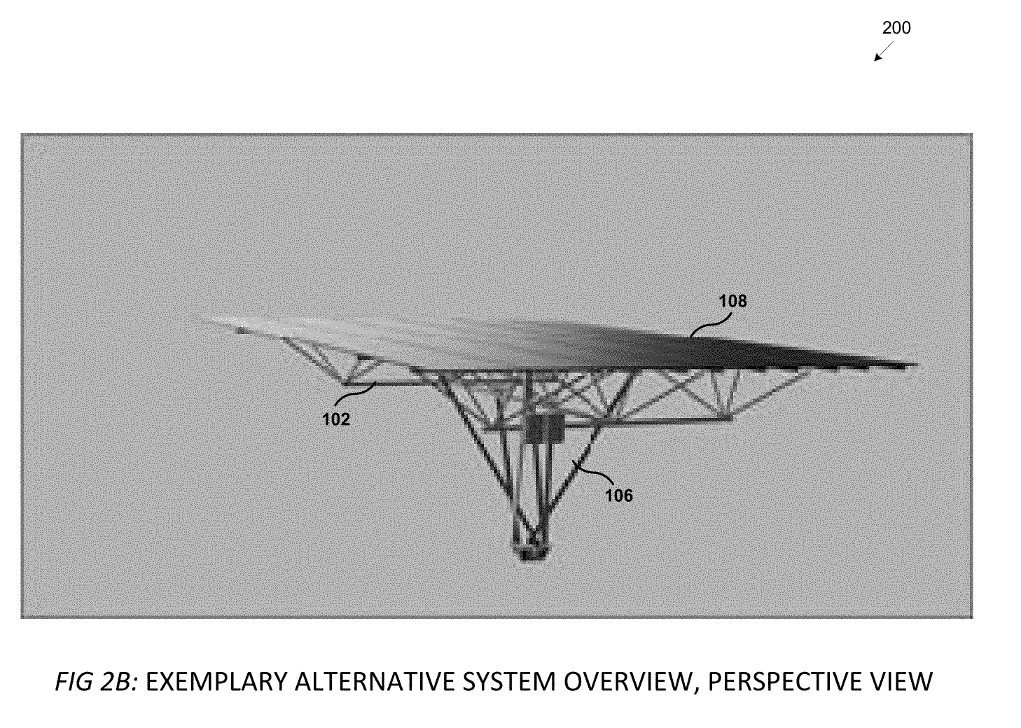

Referring now to the figures, for the purposes of example and explanation of the fundamental processes and components of the disclosed apparatuses, systems, and methods, reference is made to FIG. 1 (comprising FIGS. 1A and 1B—perspective and side views, respectively), which illustrates an exemplary, high-level overview of one embodiment of the three-axis space frame structural system 100 for PV and other infrastructure applications. As will be understood and appreciated, the exemplary three-axis space frame 100 shown in FIG. 1 represents merely one approach or embodiment of the present disclosure, and other aspects are used according to various embodiments of the present disclosure. Accordingly, FIG. 2 (comprising FIGS. 2A and 2B—side and perspective views, respectively) illustrates an alternative exemplary three-axis space frame structural system 200 for PV and other infrastructure applications.

Generally, the three-axis space frame 100, 200 maximizes the available PV module (e.g., “solar panel”) support area with limited support material and foundations by transferring all loads on the modules axially to the foundation, leaving only vertical forces to resolve with little to no lateral loads or moments, which results in the three-axis space frame 100, 200 being generally structurally autonomous. For ease of view, no PV modules are shown in FIG. 1A.

In various embodiments, the disclosed three-axis space frame 100, 200 generally comprises one or more primary axis space frames 102, secondary axis space frames 104, and tertiary axis space frames 106. In one embodiment, the primary axis space frames 102 run parallel to each other and support one or multiple PV panels 108 or other loads. The secondary axis space frames 104, in one embodiment, run perpendicular to the primary axis space frames 102, connecting and supporting the primary axis space frames 102. Generally, the tertiary axis space frames 106 attach the secondary axis space frames 104 to the ground or alternative boundary condition (e.g., parking garage, underwater foundation, flotation device, etc.), thereby supporting the three-axis space frame 100, 200.

In one embodiment, two or more primary axis space frames 102 may be separated in space along either side of a center line to support and stabilize one or more planes of solar collectors (e.g., PV panels) or other PV system components (e.g., inverters, battery storage, electric vehicle charging stations, other auxiliary equipment, etc.). Said two or more primary axis space frames 102 may, in one embodiment, be joined by one or more secondary axis space frames 104 and supported directly by a tertiary axis space frame 106, indirectly by the secondary axis space frame 104, or through a combination of direct and indirect support. In one embodiment, the primary axis space frame 102 and secondary axis space frame 104 are supported by a post and beam substructure in lieu of a tertiary space frame 106. Generally, the system 100 comprises one secondary axis space frame 104 for every tertiary axis space frame 106 (or other boundary condition). In one embodiment, the system 100 comprises two primary axis space frames 102. In one embodiment, the system 100 comprises multiple pairs of primary axis space frames 102 (e.g., four primary axis space frames 102, six primary axis space frames, etc.).

In various embodiments, each primary axis space frame 102 comprises three parallel chords (e.g., two upper chords 112 and one lower chord 114) and a series of connecting struts 116. In various embodiments, each secondary axis space frame 104 comprises three parallel chords (e.g., one upper chord 112 and two lower chords 114) and a series of connecting struts 116. The tertiary axis space frame 106, in one embodiment, may be composed of fixed-length or variable-length struts 118 for the purpose of changing the orientation of the solar collector surface(s). The struts 118 may be affixed to one or more of the upper chords 112 or lower chords 114 of the primary axis space frame 102 and lower axis space frame 104 (depending on the anticipated load conditions for the system 100). Generally, two or more struts 116, 118 connect to chords 112, 114 at connection points (also referred to herein as “nodes” or “panel points”) to accommodate greater or lesser loads across greater or lesser spans. As will be understood, this disclosure places no limitations on the composition of the space frames 102, 104, 106.

The space frames 102, 104, 106 are, in various embodiments, connected by a connection system that allows for at least one primary axis space frame 102, one secondary axis space frame 104, and one tertiary axis space frame 106 to share both struts and nodes such that a single element 110 (e.g., node 110a, strut 110b, etc.) fulfills the same structural function for multiple space frames 102, 104, 106. In one embodiment, a single element 110 may join the struts of two or more space frames 102, 104, 106 and at least one chord. In one embodiment, the upper chord 112 of the secondary axis space frame 104 may be affixed at either end to nodes on the upper chords 112 of two primary axis space frames 102. In one embodiment, the lower chords 114 may be each affixed at either end to nodes on the lower chords 114 of two primary axis space frames 102.

According to various embodiments, a support for the tertiary axis space frame 106 may generally terminate in monolithic columns or provide connection at or above a boundary condition surface (e.g., the ground, parking lot, parking garage, water, ballast, above ground mass, etc.). In one embodiment, the support may take multiple forms depending on the surface and subsurface conditions. The support may be, in one embodiment, a pile or pier that extends through the standoff surface into the subsurface. In an alternative embodiment, the support may be a podium that is at least partially above the surface and comprises a unitary mass or an enclosure for the balance of the system or system components. The support generally may be stationary or may rotate or translate for the purpose of changing the orientation of the solar collector surface(s). For example, in one embodiment, the support may comprise a gyroscopic flywheel for the singular or combined functions of stability and energy storage. The support, in various embodiments, may terminate at or near the surface to allow the tertiary axis space frame 106 to extend to or near the surface for the purpose of providing a continuous axial load path free of moments all the way to the surface. In one embodiment, the support may be wide relative to the strut diameters and allow for increased stability with one or more strut diameter spacing between termination points of diverging struts that crossed with or without a pinned connection above the support. As will occur to one having ordinary skill in the art, the form and capacity of the supports will generally depend on the expected loads of the system 100 and the surface above which the system 100 is installed.

In one embodiment, a multi-use cladding system (not shown in FIG. 1 or 2) may be installed around the tertiary axis space frame 106 and optionally around the secondary axis space frame 104 and primary axis space frame 102 for one or more functional purposes (e.g., security, water collection, light diffusion, signage, etc.). For security, the cladding generally prevents direct access to struts or strut connections. For water collection, the cladding generally collects and or channels water to a specific location. For light diffusion, partially transparent cladding may generally diffuse light(s) on the interior of the system to illuminate the exterior of said cladding. For signage, a combination of markings and/or text generally may be printed on or otherwise applied to the cladding for communication with installation staff, operating staff, or the general public.

In one embodiment, as shown in FIG. 1B, a fixed tilt rail mounted PV system, where the rails are fastened at or near the nodes and cantilever past the outer chords for additional surface area (e.g., more than 50′), may employ the system 100. Generally, the structural loads imparted on the PV panels are transferred into the three-axis space frame 100 at or near the nodes then transferred axially through the primary axis space frame 102 (highlighted by dotted triangles), into the secondary axis space frame 104 (highlighted by a dotted trapezoid), then to the tertiary axis space frame 106, and ultimately to a single foundation or other boundary condition. Alternatively, in one embodiment, loads may bypass the secondary axis space frame 104 and travel directly from the primary axis space frame 102 to the tertiary axis space frame 106. Overall, this system 100 provides structural support across a wide cross section and transfer loads to a single foundation point without risk of tipping over due to its inherently balanced structure.

The foregoing description of the exemplary embodiments has been presented only for the purposes of illustration and description and is not intended to be exhaustive or to limit the inventions to the precise forms disclosed. Many modifications and variations are possible in light of the above teaching. While various aspects have been described in the context of a preferred embodiment, additional aspects, features, and methodologies of the claimed inventions will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

What is claimed is:

1. A three-axis space frame structural system, comprising:
at least two primary axis space frames, wherein the at least two primary axis space frames are generally oriented parallel to each other and to a primary axis and wherein each of the at least two primary axis space frames comprises at least two upper chords;
at least one secondary axis space frame operatively connected to the at least two primary axis space frames, wherein the at least one secondary axis space frame is generally oriented perpendicular to the primary axis and parallel to a secondary axis;
at least one tertiary axis space frame operatively connected to the at least one secondary axis space frame, wherein the at least one tertiary axis space frame is generally oriented perpendicular to the primary and secondary axes and parallel to a tertiary axis; and
at least one photovoltaic panel affixed to one or more of the at least two upper chords.

2. The system of claim 1, wherein each of the at least two primary axis space frames further comprises at least one lower chord, wherein the at least one secondary axis space frame comprises at least one upper chord and at least two lower chords, and wherein the at least one upper chord is affixed to at least one of the at least two upper chords and the at least two lower chords are affixed to the at least one of the at least one lower chord.

3. The system of claim 2, wherein the at least one tertiary axis space frame comprises a plurality of struts that are affixed to either the at least one upper chord or the at least two lower chords.

4. The system of claim 3, wherein the at least one tertiary axis space frame is further operatively connected to at least one of the at least two primary axis space frames and wherein the plurality of struts are further affixed to either the at least two upper chords or the at least one lower chord.

5. The system of claim 4, wherein the at least one tertiary axis space frame is further operatively connected to a boundary condition comprising a pedestal, a building, a parking lot, or a parking garage, and wherein the tertiary axis is generally oriented perpendicular to the boundary condition.

6. The system of claim 1, further comprising at least two secondary axis space frames operatively connected to the at least two primary axis space frames and generally oriented perpendicular to the primary axis and parallel to the secondary axis and each other.

7. The system of claim 6, further comprising at least two tertiary axis space frames, wherein each of the at least two tertiary axis space frames is operatively connected to at least one of the at least two secondary axis space frames and is generally oriented perpendicular to the primary and secondary axes and parallel to the tertiary axis and each other.

8. The system of claim 7, further comprising at least four primary axis space frames generally oriented parallel to each other and to the primary axis.

9. A three-axis space frame structural system, comprising:
at least two primary axis space frames, wherein the at least two primary axis space frames are generally oriented parallel to each other and to a primary axis and wherein each of the at least two primary axis space frames comprises at least two upper chords;
at least one secondary axis space frame operatively connected to the at least two primary axis space frames, wherein the at least one secondary axis space frame is generally oriented perpendicular to the primary axis and parallel to a secondary axis;
at least one tertiary axis space frame operatively connected to at least one of the at least two primary axis space frames, wherein the at least one tertiary axis space frame is generally oriented perpendicular to the primary and secondary axes and parallel to a tertiary axis; and
at least one photovoltaic panel affixed to one or more of the at least two upper chords.

10. The system of claim 9, wherein each of the at least two primary axis space frames further comprises at least one lower chord, wherein the at least one secondary axis space frame comprises at least one upper chord and at least two lower chords, and wherein the at least one upper chord is affixed to at least one of the at least two upper chords and the at least two lower chords are affixed to the at least one of the at least one lower chord.

11. The system of claim 10, wherein the at least one tertiary axis space frame comprises a plurality of struts that are affixed to either the at least two upper chords or the at least one lower chord.

12. The system of claim 11, wherein the at least one tertiary axis space frame is further operatively connected to the at least one secondary axis space frame and wherein the plurality of struts are further affixed to either the at least one upper chord or the at least two lower chords.

13. The system of claim 12, wherein the at least one tertiary axis space frame is further operatively connected to a boundary condition comprising a pedestal, a building, a parking lot, or a parking garage, and wherein the tertiary axis is generally oriented perpendicular to the boundary condition.

14. The system of claim 9, further comprising at least two secondary axis space frames operatively connected to the at least two primary axis space frames and generally oriented perpendicular to the primary axis and parallel to the secondary axis and each other.

15. The system of claim 14, further comprising at least two tertiary axis space frames, wherein each of the at least two tertiary axis space frames is operatively connected to at least one of the at least two primary axis space frames and is generally oriented perpendicular to the primary and secondary axes and parallel to the tertiary axis and each other.

16. The system of claim 15, further comprising at least four primary axis space frames generally oriented parallel to each other and to the primary axis.

17. A method of installing a three-axis space frame structural system, comprising the steps of:
assembling at least two primary axis space frames, wherein each of the at least two primary axis space frames comprises at least two upper chords;
assembling at least one secondary axis space frame;
affixing the at least one secondary axis space frame to the at least two primary axis space frames such that the at least two primary axis space frames are generally oriented parallel to each other and to a primary axis and the at least one secondary axis space frame is generally oriented perpendicular to the primary axis and parallel to a secondary axis;
affixing one or more photovoltaic panels to the upper chords; and
affixing the at least one secondary axis space frame or at least one of the at least two primary axis space frames to a tertiary axis space frame such that the at least one tertiary axis space frame is generally oriented perpendicular to the primary and secondary axes and parallel to a tertiary axis.

18. The method of claim 17, further comprising the step of affixing the tertiary axis space frame to a boundary condition comprising a pedestal, a building, a parking lot, or a parking garage, wherein the tertiary axis is generally oriented perpendicular to the boundary condition.

19. The method of claim 17, wherein the step of assembling at least one secondary axis space frame further comprises the step of assembling at least two secondary axis space frames.

20. The method of claim 17, wherein the step of affixing the at least one secondary axis space frame or the at least one of the at least two primary axis space frames to a tertiary axis space frame further comprises the step of affixing both the at least one secondary axis space frame and the at least one of the at least two primary axis space frames to a tertiary axis space frame.
